(19) United States
(12) Patent Application Publication
(10) Pub. No.: US 2019/0348701 A1
(43) Pub. Date: Nov. 14, 2019

(54) BATTERY ASSEMBLY WITH HEAT EXCHANGE DEVICE AND UNIFIED FRAME

(71) Applicant: GM Global Technology Operations LLC, Detroit, MI (US)

(72) Inventors: Michael P. Balogh, Novi, MI (US); Ryan C. Sekol, Grosse Pointe Woods, MI (US); Megan E. McGovern, Royal Oak, MI (US); Teresa J. Rinker, Royal Oak, MI (US); Ingrid A. Rousseau, Clawson, MI (US)

(73) Assignee: GM Global Technology Operations LLC, Detroit, MI (US)

(21) Appl. No.: 15/977,438

(22) Filed: May 11, 2018

(51) Int. Cl. H01M 10/04; H01M 10/615; B29C 64/10

(52) U.S. Cl. CPC H01M 10/045; H01M 10/615; H01M 10/0459; H01M 10/0486; B29C 64/10

(57) ABSTRACT

A battery assembly includes a heat exchange device including a first conduit with a channel and a heat exchange plate contiguous with the first conduit. A unified frame having at least one wall is configured to at least partially encapsulate the heat exchange device. A first electrode stack is positioned at the first side of the heat exchange plate and configured to fit within a first cavity defined by the at least one wall and the first side of the heat exchange plate. In one example, the first conduit of the heat exchange device is embedded within the at least one wall. In another example, the first conduit extends along the at least one wall, the first conduit being outside of the first cavity. A method of forming the battery assembly may include forming the heat exchange device and joining a unified frame.

### INTRODUCTION

The present disclosure relates generally to a battery assembly and a method for forming the battery assembly. More specifically, the disclosure relates to a battery assembly with a heat exchange device and a unified frame. The use of purely electric vehicles and hybrid vehicles, such as battery electric vehicles, range extended electric vehicles, hybrid electric vehicles, plug-in hybrid electric vehicles and fuel cell hybrid electric vehicles, requiring a rechargeable energy storage source has increased over the last few years. Many hybrid electric vehicles and purely electric vehicles employ a battery assembly made up of multiple lithium-ion cells as an energy storage source.

### SUMMARY

Disclosed herein is a battery assembly with a heat exchange device including a first conduit with a channel and a heat exchange plate contiguous with the first conduit. The heat exchange plate defines a first side and a second side. The battery assembly includes a unified frame having at least one wall configured to at least partially encapsulate the heat exchange device. A first electrode stack is positioned at the first side of the heat exchange plate and configured to fit within a first cavity defined by the at least one wall and the first side of the heat exchange plate. The first conduit defines a channel configured to enable flow of a fluid therein. Also disclosed is a method of forming the battery assembly.

The at least one wall of the unified frame may include a first wall, a second wall and a third wall. In one example, the first conduit of the heat exchange device is embedded within the first wall, the unified frame being molded over the first conduit (and forming additional walls around a perimeter of the heat exchange plate). The at least one wall of the unified frame may include a fourth wall. The second wall and the third wall may include a respective aperture coinciding with respective ends of the first conduit. In another example, the first conduit is rigidly attached to and extends along the at least one wall of the unified frame, with the first conduit being outside of the first cavity. The heat exchange device may include a second conduit contiguous with the heat exchange plate. The first conduit and the second conduit may be rigidly attached to and extend along the first wall and the third wall, respectively, the first wall being opposed to the third wall. The first conduit and the second conduit may be configured to be outside of the first cavity and the second cavity.

The battery assembly may include a first positive terminal and a first negative terminal operatively connected to the first electrode stack. The first electrode stack includes at least one first anode layer, at least one first cathode layer and at least one first separator layer. A second electrode stack may be positioned at the second side of the heat exchange plate, with the second electrode stack being configured to fit within a second cavity defined by the at least one wall and the second side of the heat exchange plate. A second positive terminal and a second negative terminal may be operatively connected to the second electrode stack. The second electrode stack includes at least one second anode layer, at least one second cathode layer and at least one second separator layer.

The first conduit may be at least partially embedded in the unified frame and may at least partially extend through the heat exchange plate. In one example, the first conduit is configured to be continuous and single (without branches). In another example, the first conduit includes a first base portion and a second base portion at least partially embedded in the unified frame and one or more sub-channels at least partially extending through the heat exchange plate. In this example, fluid may flow between the first base portion and the second base portion via one or more the sub-channels.

The first conduit of the heat exchange device may extend along a first direction. The first positive terminal and the first negative terminal extend along a second direction. In one example, the second direction is perpendicular to the first direction. In another example, the second direction is parallel to the first direction. The battery assembly may include a first protective layer operatively connected to a respective first end face of the at least one wall and configured to hermetically seal the first electrode stack in the first cavity. A second protective layer may be operatively connected to a respective second end face of the at least one wall and configured to hermetically seal the second electrode stack in the second cavity. The first and second protective layer may be composed of a laminated film.

A method of forming a battery assembly includes forming a heat exchange device with a first conduit defining a channel and a heat exchange plate contiguous with the first conduit, with the heat exchange plate defining a first side and a second side. The method includes integrally forming or joining a unified frame with the heat exchange device and configuring the unified frame with at least one wall to at least partially encapsulate the heat exchange device and provide containment for an electrolyte. The method includes forming a first electrode stack with at least one first anode layer, at least one first cathode layer and at least one first separator layer. The first electrode stack is positioned at the first side of the heat exchange plate such that the first electrode stack fits within a first cavity defined by the at least one wall and the first side of the heat exchange plate.

Joining the unified frame with the heat exchange device may include molding the unified frame over the first conduit of the heat exchange device such that the first conduit is embedded within the at least one wall of the unified frame. Joining the unified frame with the heat exchange device may include co-molding the unified frame with the first conduit of the heat exchange device such that the first conduit is rigidly attached to the at least one wall of the unified frame. The method may include integrally forming the heat exchange device and a unified frame with a sacrificial material during formation, and removing the sacrificial material after the formation to create the first conduit. The first conduit may include one or more sub-channels configured to enable flow of the fluid. The unified frame and the heat exchange device may be formed using 3-D printing or other types of additive manufacturing processes.

The method may include attaching a first protective layer to a respective first end face of the at least one wall such that the first electrode stack is hermetically sealed in the first cavity. The method may include forming a second electrode stack with at least one second anode layer, at least one second cathode layer, at least one second separator layer. The second electrode stack is positioned at the second side of the heat exchange plate such that the second electrode stack fits within a second cavity defined by the at least one wall and the second side of the heat exchange plate. The method may include attaching a second protective layer to a respective second end face of the at least one wall such that the second electrode stack is hermetically sealed in the second cavity.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic perspective view of a battery assembly having a heat exchange device and a unified frame, in accordance with a first embodiment;

FIG. 2 is a schematic perspective view of the heat exchange device of FIG. 1;

FIG. 3 is a schematic perspective view of the unified frame and heat exchange device of FIG. 1;

FIG. 4 is a schematic exploded view of the battery assembly of FIG. 1;

FIG. 5 is a schematic exploded view of a battery assembly, in accordance with a second embodiment;

FIG. 6 is a schematic exploded view of a battery assembly, in accordance with a third embodiment;

FIG. 7A is a schematic sectional view of an alternative embodiment of a unified frame and heat exchange device;

FIG. 7B is a schematic sectional view of yet another alternative embodiment of a unified frame and heat exchange device; and

FIG. 8 is a schematic flow diagram for a method of forming a battery assembly.

### DETAILED DESCRIPTION

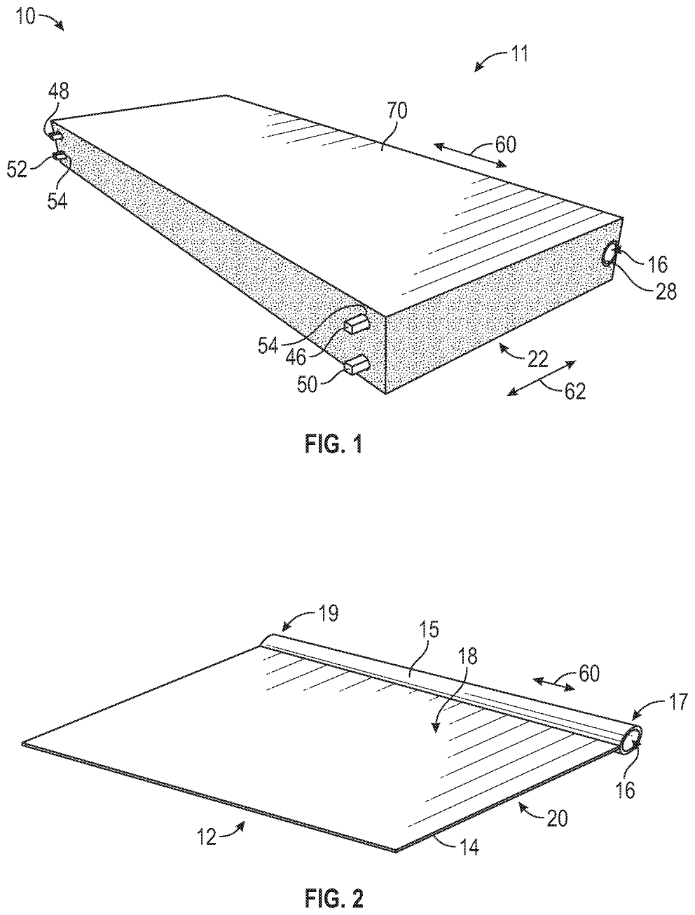

Referring to the drawings, wherein like reference numbers refer to like components, FIG. 1 is a schematic perspective view of a battery assembly 10, which may be part of a device 11. The device 11 may be a mobile platform, such as, but not limited to, a passenger car, sport utility vehicle, light truck, heavy duty vehicle, ATV, minivan, bus, transit vehicle, bicycle, robot, farm implement, sports-related equipment, boat, plane, train or other transportation device. The device 11 may be a non-mobile platform, such as, but not limited to, a desktop computer, household appliance, medical device, home automation unit and industrial automation unit. The device 11 may take many different forms and include multiple and/or alternate components and facilities.

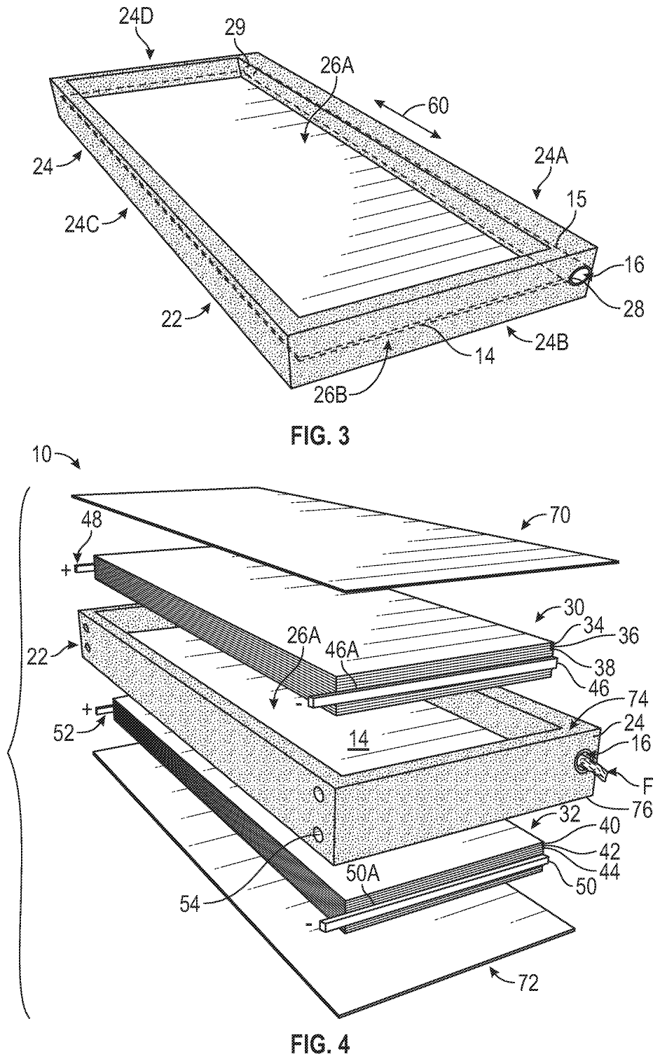

The battery assembly 10 includes a heat exchange device 12 (shown in FIGS. 2-4) and a unified frame 22 (shown in FIGS. 1, 3 and 4, lightly shaded). FIG. 2 is a schematic perspective view of the heat exchange device 12 alone. FIG. 3 is a schematic perspective view of the heat exchange device 12 with the unified frame 22. Referring to FIGS. 2-3, the heat exchange device 12 includes a heat exchange plate 14 contiguous with (i.e., at least partially sharing a boundary with) a first conduit 15. The heat exchange plate 14 may be manufactured, molded or otherwise formed with the first conduit 15 as a single integral unit, or may be manufactured, molded or otherwise formed separately as separate units and attached. Referring to FIG. 2, the first conduit 15 defines a channel 16 and extends between a first end 17 and a second end 19. Referring to FIG. 2, the heat exchange plate 14 is substantially planar and defines a first side 18 and a second side 20. The heat exchange device 12 may be composed of a thermal conductor, including but not limited to, aluminum. The cross-sectional shape of the channel 16 may be varied based on the application at hand and may include a circular section, a non-circular section or a section that varies along its length.

FIG. 4 is a schematic exploded view of the battery assembly 10. FIG. 1 shows the battery assembly 10 in the assembled form. Referring to FIGS. 3-4, the unified frame 22 may include at least one wall (such as first wall 24A) configured to at least partially encapsulate the heat exchange device 12. Referring to FIG. 3, the unified frame 22 may include a plurality of walls 24, such as a first wall 24A, a second wall 24B, a third wall 24C and a fourth wall 24D. The number of walls may be varied. For example, the unified frame 22 may include a single extended wall (such as the inner wall of a cylinder) or multiple walls. Referring to FIG. 3, the heat exchange plate 14 may intersect each of the plurality of walls 24 to form a first cavity 26A on the first side 18 of the heat exchange plate 14 and a second cavity 26B on the second side 20 of the heat exchange plate 14. The relative sizes of the first cavity 26A and second cavity 26B may be varied. For example, the heat exchange plate 14 may bisect the plurality of walls 24 to form the first cavity 26A and the second cavity 26B, where the first cavity 26A and the second cavity 26B are equal in size. The unified frame 22 may be made of a polymer, a polymer composite or other sufficiently rigid material. The unified frame 22 eliminates battery tab geometry constraints and allows for efficient battery terminal designs.

In the first embodiment shown in FIGS. 1-4, the first conduit 15 is embedded within at least one wall (such as first wall 24A) of the unified frame 22. Referring to FIG. 3, the first conduit 15 may be positioned within and extending along the first wall 24A. For example, the unified frame 22 may be molded over the first conduit 15 and a portion of the heat exchange plate 14, and the remaining portions of the plurality of walls 24 (second wall 24B, third wall 24C, fourth wall 24D) formed around a perimeter of the heat exchange plate 14. Referring to FIG. 3, the second wall 24B and the fourth wall 24D may include first and second apertures 28, 29 coinciding with the first and second ends 17, 19 (see FIG. 2), respectively, of the first conduit 15. In other words, the first conduit 15 may extend between a first aperture 28 at the second wall 24B and a second aperture 29 at the fourth wall 24D. Referring to FIG. 4, channel 16 of the first conduit 15 may be configured to enable flow of a fluid F. The fluid F may be in a liquid or gas form and configured to cool or heat its surroundings.

Referring to FIG. 4, a first electrode stack 30 is positioned at the first side 18 (shown in FIG. 2) of the heat exchange plate 14. The first electrode stack 30 is configured to fit within the first cavity 26A defined by the plurality of walls 24 and the first side 18 of the heat exchange plate 14. A second electrode stack 32 may be positioned at the second side 20 (shown in FIG. 2) of the heat exchange plate 14, with the second electrode stack 32 being configured to fit within the second cavity 26B defined by the plurality of walls 24 and the second side 18 of the heat exchange plate 14.

Referring to FIG. 4, the first electrode stack 30 includes at least one first anode layer 34, at least one first cathode layer 38 and at least one first separator layer 36. The second electrode stack 32 includes at least one second anode layer 40, at least one second cathode layer 44 and at least one second separator layer 42. The first anode layer 34 and the second anode layer 40 may be composed of semi-graphitic carbons. The first cathode layer 38 and the second cathode layer 44 may be composed of lithiated metal oxides or metal phosphates. The first separator layer 36 and the second separator layer 42 may be composed of a micro-porous and dielectric material. It is understood that other suitable materials available to those skilled in the art may be employed for the above-mentioned layers. The first electrode stack 30 and the second electrode stack 32 may be filled with an electrolyte (not shown), which may include a lithium salt dissolved into a non-aqueous organic solution. The first electrode stack 30 and the second electrode stack 32 may be configured to utilize the movement of lithium ions as a way of energy storage and delivery.

Referring to FIGS. 1 and 4, the battery assembly 10 may include a first positive terminal 46 and a first negative terminal 48 operatively connected to the first electrode stack 30. The first positive terminal 46 and the first negative terminal 48 may be joined to the first electrode stack 30 using methods available to those skilled in the art, including but not limited to, ultrasonic welding, laser welding, rolling foils (or using plates) around the respective terminals and crimping/welding. Alternatively, the first positive terminal 46 and the first negative terminal 48 may be seated in a respective recess 46A in the first electrode stack 30. The shapes of the first positive terminal 46 and the first negative terminal 48 may be varied based on the application at hand.

Similarly, referring to FIGS. 1 and 4, the battery assembly 10 may include a second positive terminal 50 and a second negative terminal 52 operatively connected to the second electrode stack 32. The second positive terminal 50 and the second negative terminal 52 may be joined to the second electrode stack 32 via the multiple methods noted above. Alternatively, the second positive terminal 50 and the second negative terminal 52 may be seated in a respective recess 50A in the second electrode stack 32. The at least one wall 24 may include a respective aperture 54 for each of the terminals described above to pass through the unified frame 22 in order to allow for electrical connections. The shapes of the second positive terminal 50 and the second negative terminal 52 may be varied based on the application at hand.

Referring to FIGS. 1 and 2, the first conduit 15 of the heat exchange device 12 extends along a first direction 60. The first positive terminal 46 and the first negative terminal 48 extend along a second direction 62, as shown in FIG. 1. In the first embodiment shown in FIGS. 1 and 4, the second direction 62 is perpendicular to the first direction 60.

Referring to FIGS. 1 and 4, the battery assembly 10 may include a first protective layer 70 and a second protective layer 72. Referring to FIG. 4, the first protective layer 70 may be operatively connected to respective first end faces 74 of the plurality of walls 24 and configured to hermetically seal the first electrode stack 30 in the first cavity 26A. The first protective layer 70 is configured to enclose the first electrode stack 30 in the unified frame 22. Referring to FIG. 4, the second protective layer 72 may be operatively connected to respective second end faces 76 of the plurality of walls 24 and configured to hermetically seal the second electrode stack 32 in the second cavity 26B. The second protective layer 72 is configured to enclose the second electrode stack 32 in the unified frame 22. The first protective layer 70 and the second protective layer 72 may be composed of a laminated film. In one example, the laminated film is composed of a layer of aluminum sandwiched between two layers of polymer film.

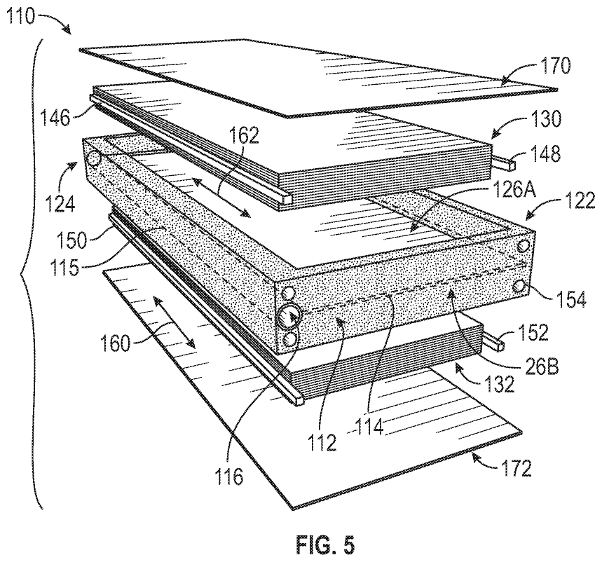

Referring to FIG. 5, a schematic exploded view of a battery assembly 110 is shown, in accordance with a second embodiment. The battery assembly 110 includes a heat exchange device 112 with a first conduit 115 defining a channel 116 and a heat exchange plate 114 contiguous with the first conduit 115. A unified frame 122 has at least one wall 124 configured to encapsulate the heat exchange device 112. Referring to FIG. 5, a first electrode stack 130 and a second electrode stack 132 are positioned on either side of the heat exchange plate 114. Similar to the first embodiment, the first electrode stack 130 and the second electrode stack 132 are configured to fit within a first cavity 126A and a second cavity 126B, respectively. A first positive terminal 146 and a first negative terminal 148 may be operatively connected to the first electrode stack 130. A second positive terminal 150 and a second negative terminal 152 may be operatively connected to the second electrode stack 132. The at least one wall 124 may include a respective aperture 154 for each of the terminals described above to pass through the unified frame 122 in order to allow for electrical connections.

Referring to FIG. 5, the first conduit 115 of the heat exchange device 112 extends along a first direction 160. The first positive terminal 146 and the first negative terminal 148 extend along a second direction 162. In the embodiment shown in FIG. 5, the second direction 162 is parallel to the first direction 160. A first protective layer 170 may be operatively connected to the at least one wall 124 and configured to hermetically seal the first electrode stack 130 in the first cavity 126A. A second protective layer 172 may be operatively connected to the at least one wall 124 and configured to hermetically seal the second electrode stack 132 in the second cavity 126B.

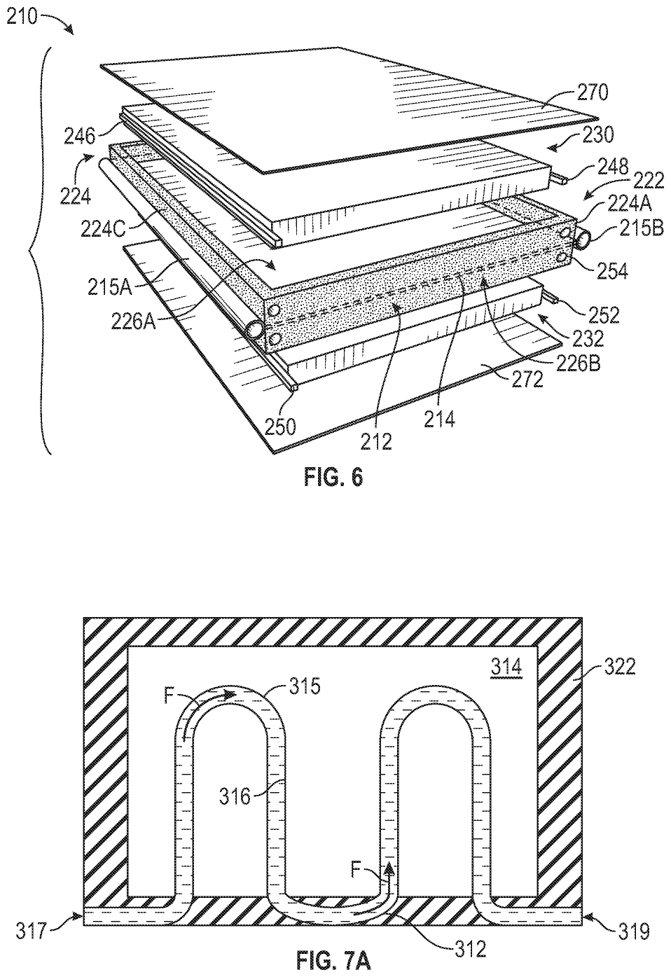

Referring to FIG. 6, a schematic exploded view of a battery assembly 210 is shown, in accordance with a third embodiment. In the embodiment shown in FIG. 6, the first conduit 215A is rigidly attached to and extends along the at least one wall 224 of the unified frame 222. Referring to FIG. 6, the heat exchange device 212 may include a second conduit 215B contiguous with the heat exchange plate 214 and rigidly attached to the at least one wall 224. The first conduit 215A and the second conduit 215B may extend along the third wall 224C and the first wall 224A, respectively, the first wall 224A being opposed to the third wall 224C. The first conduit 215A and the second conduit 215B are configured to be outside of the cavity 226 defined by the at least one wall 224.

Referring to FIG. 6, a first electrode stack 230 and a second electrode stack 232 are positioned on either sides of the heat exchange plate 214. Similar to the first embodiment, the first electrode stack 230 and the second electrode stack 232 are configured to fit within a first cavity 226A and a second cavity 226B, respectively. A first positive terminal 246 and a first negative terminal 248 may be operatively connected to the first electrode stack 230. A second positive terminal 250 and a second negative terminal 252 may be operatively connected to the second electrode stack 232. The at least one wall 224 may include a respective aperture 254 for each of the terminals described above to pass through the unified frame 222 in order to allow for electrical connections. A first protective layer 270 may be operatively connected to the at least one wall 224 and configured to hermetically seal the first electrode stack 230 in the first cavity 226A. A second protective layer 272 may be operatively connected to the at least one wall 224 and configured to hermetically seal the second electrode stack 232 in the second cavity 226B.

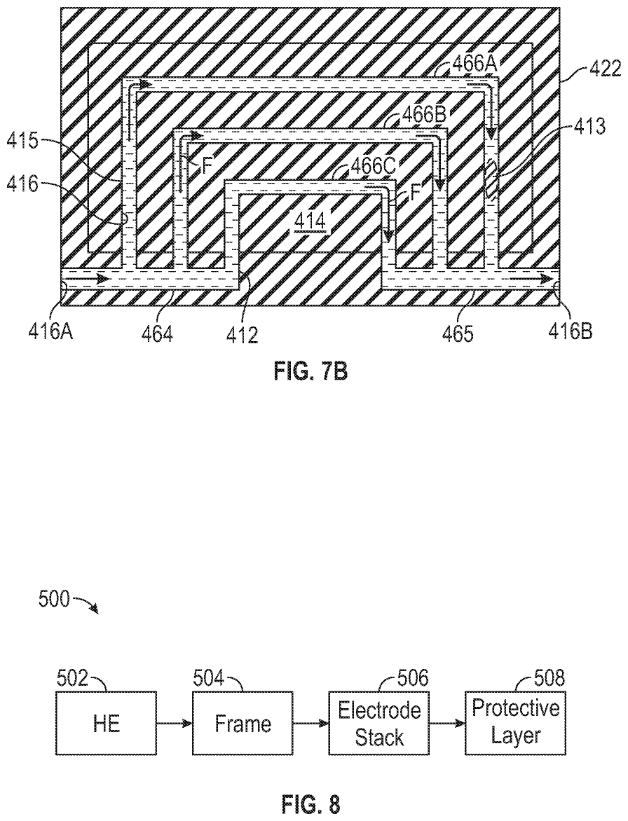

FIG. 7A is a schematic sectional view of an alternative embodiment, showing a heat exchange device 312 and a unified frame 322. Referring to FIG. 7A, the heat exchange device 312 includes a heat exchange plate 314 (in the plane of the page) contiguous with or connected to a first conduit 315. The first conduit 315 defines a channel 316 configured to enable flow of a fluid F therein. The first conduit 315 is at least partially embedded in the unified frame 322 and may at least partially extend into the heat exchange plate 314. In the example shown, the channel 316 is continuous and single (without branches), extending between a first end 317 and a second end 319. In one example, the channel 316 is characterized by a sinusoidal shape. It is to be understood that other suitable shapes may be employed.

FIG. 7B is a schematic sectional view of yet another alternative embodiment showing a heat exchange device 412 and a unified frame 422. Referring to FIG. 7B, the unified frame 422 may be integrally formed with the heat exchange device 412, such that the heat exchange device 412 and the unified frame 422 are composed of the same material. Alternatively, the heat exchange device 412 may be composed of a different material than the unified frame 422 and joined after being separately formed. Referring to FIG. 7B, the heat exchange device 412 includes a heat exchange plate 414 (in the plane of the page) contiguous with or connected to a first conduit 415. The first conduit 415 defines a channel 416 configured to enable flow of a fluid F therein. The first conduit 415 is at least partially embedded in the unified frame 422 and may at least partially extend into the heat exchange plate 414. The first conduit 415 may include a first base portion 464 and a second base portion 465 in fluid communication with one or more sub-channels, such as sub-channels 466A, 466B, 466C. As shown by the arrows in FIG. 7B, the fluid F may flow from the first base portion 464 through the sub-channels 466A, 466B, 466C and to the second base portion 465. The opposing sections 416A, 416B of the first conduit 415 may be reduced or made discontinuous to regulate the flow of fluid F.

The sub-channels 466A, 466B, 466C may be spread over the heat exchange plate 314 to provide for an efficient and distributed cooling (or heating) effect. The sub-channels 466A, 466B, 466C may be U-shaped, S-shaped or employ other suitable shapes. It is to be understood that other suitable shapes and/or combination of sub-channels may be employed to optimize the thermal management performance. The sub-channels 466A, 466B, 466C and the first conduit 415 may be formed using a sacrificial material 413 that forms the sub-channels within the unified frame 422 during the forming process of the unified frame 422 and then gets “sacrificed” after the molding process is completed. The sacrificial material 413 may be removed to form the “empty” channel/space for flow of the fluid F (i.e., sub-channels 466A, 466B, 466C and the first conduit 415) by melting, decomposing or other methods adapted to the selected sacrificial material 413.

It is to be understood that the features shown in separate figures may be combined. The battery assembly 10, battery assembly 110 and battery assembly 210 provide a technical advantage of increased specific energy and increased efficiency, reduction in the number of components, reduced complexity and reduced cost of automotive battery packs and modules. As used herein, the term “battery” or “battery pack” refers to an electric storage device having at least two cells. The term “cell” or “battery cell” refers to an electrochemical cell made of at least one positive electrode, at least one negative electrode, an electrolyte, and a separator.

Referring now to FIG. 8, a flowchart of a method 500 of forming the battery assembly 10, battery assembly 110 and battery assembly 210 is shown. Method 500 need not be applied in the specific order recited herein. Furthermore, it is to be understood that some steps may be eliminated.

Referring to FIG. 8, method 500 may begin with block 502, where a heat exchange device 12 (or heat exchange device 112/212/312/412) is formed. In the embodiment shown in FIG. 1, the heat exchange device 12 includes a first conduit 15 defining a channel 16 and a heat exchange plate 14 contiguous with the first conduit 15, with the heat exchange plate 14 defining a first side 18 and a second side 20. The heat exchange plate 14 may be molded with the first conduit 15 as a single integral unit. The heat exchange plate 14 and the first conduit 15 may be molded separately as separate units and attached, for example, via welding, through the use of an adhesive or other suitable method available to those skilled in the art. The heat exchange device 112/212/312/412 and the unified frame 122/222/322/422 may be formed using compression molding, co-molding, 3-D printing or other types of additive manufacturing processes. As understood by those skilled in the art, 3-D printing generally involves forming a three-dimensional object from a computer model or file, such as a computer-aided design (CAD) model, by successively adding materials layer by layer.

In the embodiment shown in FIG. 6, the heat exchange device 212 includes a heat exchange plate 214 contiguous with a first conduit 215A and a second conduit 215B. The first conduit 215A and the second conduit 215B may be on opposing sides or adjacent sides of the heat exchange plate 214. The heat exchange plate 214 may be molded with the first conduit 215A and the second conduit 215B as a single integral unit or molded separately and attached.

Per block 504 of FIG. 8, the method 500 includes joining or integrally forming the unified frame 22 (or unified frame 122/222/322/422) with the heat exchange device 12 (or heat exchange device 112/212/312/412). The unified frame 22 may be configured with at least one wall 24 to at least partially encapsulate the heat exchange device 12. In the embodiment shown in FIGS. 1 and 3-4, joining the unified frame 22 with the heat exchange device 12 includes molding the unified frame 22 over the first conduit 15 of the heat exchange device 12 such that the first conduit 15 is embedded within at least one wall, such as first wall 24A, of the unified frame 22. The remaining parts of the wall 24 (second wall 24B, third wall 24C, fourth wall 24D) may be formed around a perimeter of the heat exchange plate 14. In the embodiment shown in FIG. 6, joining the unified frame 222 with the heat exchange device 212 includes co-molding the unified frame 222 with the first conduit 215A and the second conduit 215B such that the first conduit 215A and the second conduit 215B are outside of the cavity 226 and rigidly attached to the at least one wall 224.

Referring to FIG. 7B, the unified frame 422 may be integrally formed with the heat exchange device 412. As described above with respect to FIG. 7B, the sub-channels 466A, 466B, 466C and the first conduit 415 may be formed using a sacrificial material 413 that forms the sub-channels within the unified frame 422 during the forming process of the unified frame 422. The sacrificial material 413 is removed after the forming process is completed to form the “empty” channel/space for flow of the fluid F (i.e., sub-channels 466A, 466B, 466C and the first conduit 415) by melting, decomposing or other methods available to those skilled in the art.

Per block 506 of FIG. 8, the method 500 includes forming the first electrode stack 30 (or first electrode stack 130 in FIG. 5 or first electrode stack 230 in FIG. 6) with at least one first anode layer 34, at least one first cathode layer 36 and at least one first separator layer 38, and positioning the first electrode stack 30 in the first cavity 26A. Block 506 may include forming a second electrode stack 32 (or second electrode stack 132 in FIG. 5 or second electrode stack 232 in FIG. 6) with at least one second anode layer 40, at least one second cathode layer 42, at least one second separator layer 44, and positioning the second electrode stack 32 in the second cavity 26B. Block 506 may include filling the first electrode stack 30 and the second electrode stack 32 with an electrolyte, which may include a lithium salt dissolved into a non-aqueous organic solution.

Per block 508 of FIG. 8, the method 500 includes attaching a first protective layer 70 (or first protective layer 170 in FIG. 5 or first protective layer 270 in FIG. 6) to respective first end faces 74 of the plurality of walls 24 such that the first electrode stack 30 is hermetically sealed in the first cavity 26A (see FIG. 4). Block 508 may include attaching a second protective layer 72 (or second protective layer 172 in FIG. 5 or second protective layer 272 in FIG. 6) to respective second end faces 76 of the plurality of walls 24 such that the second electrode stack 32 is hermetically sealed in the second cavity 26B. Other methods of attachment, including heat welding/pressing, may be employed.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery assembly comprising:
a heat exchange device including a first conduit and a heat exchange plate contiguous with the first conduit, the heat exchange plate defining a first side and a second side;
a unified frame having at least one wall configured to at least partially encapsulate the heat exchange device;
a first electrode stack positioned at the first side of the heat exchange plate, the first electrode stack being configured to fit within a first cavity defined by the at least one wall and the first side of the heat exchange plate; and
wherein the first conduit defines a channel configured to enable flow of a fluid therein.

2. The battery assembly of claim 1, wherein:
the at least one wall includes a first wall, a second wall and a third wall;
the first conduit of the heat exchange device is at least partially embedded within the first wall, the unified frame being molded over the first conduit; and
wherein the second wall and the third wall include a respective aperture coinciding with respective ends of the first conduit.

3. The battery assembly of claim 1, wherein:
the first conduit is rigidly attached to and extends along the at least one wall of the unified frame, the first conduit being outside of the first cavity.

4. The battery assembly of claim 1, wherein:
the heat exchange device includes a second conduit contiguous with the heat exchange plate;
the at least one wall includes a first wall, a second wall, a third wall and a fourth wall;
the first conduit and the second conduit are rigidly attached to and extend along the first wall and the third wall, respectively, the first wall being opposed to the third wall; and
the first conduit and the second conduit are outside of the first cavity and a second cavity of the unified frame.

5. The battery assembly of claim 1, further comprising:
a first positive terminal and a first negative terminal operatively connected to the first electrode stack;
wherein the first electrode stack includes at least one first anode layer, at least one first cathode layer and at least one first separator layer;
a second electrode stack configured to fit within a second cavity defined by the at least one wall and the second side of the heat exchange plate;
a second positive terminal and a second negative terminal operatively connected to the second electrode stack; and
wherein the second electrode stack includes at least one second anode layer, at least one second cathode layer and at least one second separator layer.

6. The battery assembly of claim 1, wherein:
the first conduit is at least partially embedded in the unified frame and at least partially extends into the heat exchange plate;
the first conduit is configured to be continuous and single.

7. The battery assembly of claim 1, wherein:
the first conduit includes a first base portion and a second base portion at least partially embedded in the unified frame and one or more sub-channels at least partially extending through the heat exchange plate; and
wherein the fluid flows between the first base portion and the second base portion via one or more the sub-channels.

8. The battery assembly of claim 1, further comprising:
a first positive terminal and a first negative terminal operatively connected to the first electrode stack;
wherein the first conduit of the heat exchange device extends along a first direction;
wherein the first positive terminal and the first negative terminal extend along a second direction, the second direction being perpendicular to the first direction.

9. The battery assembly of claim 1, further comprising:
a first positive terminal and a first negative terminal operatively connected to the first electrode stack;
wherein the first conduit of the heat exchange device extends along a first direction;
wherein the first positive terminal and the first negative terminal extend along a second direction, the second direction being parallel to the first direction.

10. The battery assembly of claim 1, further comprising:
a first protective layer operatively connected to a respective first end face of the at least one wall and configured to hermetically seal the first electrode stack in the first cavity; and
wherein the first protective layer is composed of a laminated film.

11. A method of forming a battery assembly, the method comprising:
forming a heat exchange device with a first conduit defining a channel configured to enable flow of a fluid therein and a heat exchange plate contiguous with the first conduit, the heat exchange plate defining a first side and a second side;
integrally forming or joining a unified frame with the heat exchange device and configuring the unified frame with at least one wall to at least partially encapsulate the heat exchange device;
forming a first electrode stack with at least one first anode layer, at least one first cathode layer and at least one first separator layer; and
positioning the first electrode stack at the first side of the heat exchange plate such that the first electrode stack fits within a first cavity defined by the at least one wall and the first side of the heat exchange plate.

12. The method of claim 11, wherein joining the unified frame with the heat exchange device includes:
molding the unified frame over the first conduit of the heat exchange device such that the first conduit is embedded within the at least one wall of the unified frame.

13. The method of claim 11, wherein joining the unified frame with the heat exchange device includes:
co-molding the unified frame with the first conduit of the heat exchange device such that the first conduit is rigidly attached to the at least one wall of the unified frame.

14. The method of claim 11, wherein integrally forming the unified frame with the heat exchange device includes:
integrally forming the heat exchange device and a unified frame with a sacrificial material during formation;
removing the sacrificial material after the formation to create the first conduit, the first conduit including one or more sub-channels configured to enable flow of the fluid.

15. The method of claim 11, wherein the heat exchange device and the unified frame are formed via 3-D printing.

16. The method of claim 11, further comprising:
attaching a first protective layer to respective first end faces of the at least one wall such that the first electrode stack is hermetically sealed in the first cavity;
forming a second electrode stack with at least one second anode layer, at least one second cathode layer, at least one second separator layer;
positioning the second electrode stack at the second side of the heat exchange plate such that the second electrode stack fits within a second cavity defined by the at least one wall and the second side of the heat exchange plate; and
attaching a second protective layer to respective second end faces of the at least one wall such that the second electrode stack is hermetically sealed in the second cavity.

17. A battery assembly comprising:
a heat exchange device including a first conduit, a heat exchange plate contiguous with the first conduit, the heat exchange plate defining a first side and a second side;
a unified frame having at least one wall configured to at least partially encapsulate the heat exchange device;
a first electrode stack positioned at the first side of the heat exchange plate, the first electrode stack being configured to fit within a first cavity defined by the at least one wall and the first side of the heat exchange plate;
wherein the first conduit defines a channel configured to enable flow of a fluid therein, the first conduit including one or more sub-channels at least partially extending through the heat exchange plate.

18. The battery assembly of claim 17, wherein:
the at least one wall includes a first wall, a second wall and a third wall;
the first conduit of the heat exchange device is at least partially embedded within the first wall, the unified frame being molded over the first conduit; and
wherein the second wall and the third wall include a respective aperture coinciding with respective ends of the first conduit.

19. The battery assembly of claim 17, wherein:
the heat exchange device includes a second conduit contiguous with the heat exchange plate;
the at least one wall includes a first wall, a second wall, a third wall and a fourth wall;
the first conduit and the second conduit are rigidly attached to and extend along the first wall and the third wall, respectively, the first wall being opposed to the third wall; and
the first conduit and the second conduit are outside of the first cavity and a second cavity of the unified frame.

20. The battery assembly of claim 17, further comprising:
a first positive terminal and a first negative terminal operatively connected to the first electrode stack, the first electrode stack including at least one first anode layer, at least one first cathode layer and at least one first separator layer;
a second electrode stack positioned at the second side of the heat exchange plate, the second electrode stack being configured to fit within a second cavity defined by the at least one wall and the second side of the heat exchange plate;
a second positive terminal and a second negative terminal operatively connected to the second electrode stack;
a first protective layer operatively connected to a respective first end face of the at least one wall and configured to hermetically seal the first electrode stack in the first cavity;
a second protective layer operatively connected to a respective second end face of the at least one wall and configured to hermetically seal the second electrode stack in the second cavity; and
wherein the second electrode stack includes at least one second anode layer, at least one second cathode layer and at least one second separator layer.
